(19) United States
(12) Patent Application Publication
(10) Pub. No.: US 2025/0315693 A1
(43) Pub. Date: Oct. 9, 2025

(54) EXPLAINABLE ARTIFICIAL INTELLIGENCE APPARATUS AND METHOD FOR ANALYZING MODEL THEREOF

(71) Applicant: Konan Technology Inc., Seoul (KR)

(72) Inventors: Kyeongsoo KIM, Seoul (KR); Jaehyeok JEONG, Seoul (KR); Juhyun LEE, Gunpo-si (KR); Hyeongdo LEE, Seongnam-si (KR); Hyunsu KANG, Yongin-si (KR)

(73) Assignee: Konan Technology Inc., Seoul (KR)

(21) Appl. No.: 18/659,480

(22) Filed: May 9, 2024

(30) Foreign Application Priority Data
Apr. 5, 2024 (KR) 10-2024-0046696

(51) Int. Cl. G06N 5/022

(52) U.S. Cl. CPC G06N 5/022

(57) ABSTRACT

Provided are an explainable artificial intelligence (XAI) apparatus and a method for analyzing a model thereof. The XAI apparatus according to the present invention may use bytecode of a model to generate a model graph even for models including dynamic control flow, which are otherwise unable to generate a graph, in order to provide visualization of the decision-making process of an XAI algorithm.

### CROSS-REFERENCE TO RELATED APPLICATION(S)

This application claims the benefit under 35 USC § 119(a) of Korean Patent Application No. 10-2024-0046696, filed on Apr. 5, 2024, in the Korean Intellectual Property Office, the entire disclosure of which is incorporated herein by reference for all purposes.

### BACKGROUND

### 1. Field

The following description relates to a technology for describing a determination basis for inference results of an artificial intelligence model in a manner understandable to humans.

### 2. Description of Related Art

As the development of artificial intelligence (AI, hereinafter, referred to as “AI”) technology continues to have a significant impact on various fields, most AI techniques reveal limitations in explaining their internal decision-making basis. Consequently, there is a growing need for explainable artificial intelligence (XAI) technology that can explain the rationale behind the decisions made by AI models.

XAI is used to explain AI models and their expected impacts and potential biases. It is useful in characterizing model accuracy, fairness, transparency, and outcomes in AI-driven decision-making. XAI plays a crucial role in building trust and confidence when organizations deploy AI models for production. In addition, explainability through AI helps organizations adopt a responsible approach to AI development.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

According to an embodiment, an explainable artificial intelligence (XAI) apparatus and a method for analyzing a model thereof that present a determination basis for inference results of an AI model in a manner understandable to humans.

In one general aspect, there is provided an XAI apparatus including a bytecode analyzer configured to analyze a computational structure of a model based on bytecode of an AI model including dynamic control flow, and a bytecode tracer configured to generate a model graph for providing visualization of decision-making process of an XAI algorithm using an analysis result from the bytecode analyzer.

The bytecode analyzer may include a bytecode converter configured to convert a function or method of the model into bytecode and an operational structure table generator configured to generate an operational structure table (OP-CODE table) by arranging the converted bytecode.

The bytecode tracer may include an operational structure table analyzer configured to receive the operational structure table from the bytecode analyzer and analyze it and a graph tree generator configured to generate a graph tree for the model using the analyzed operational structure table.

The graph tree generator may store a calculation result of an operation process in the trace table while analyzing the operational structure table received from the bytecode analyzer, generate a variable tree by tracing a process of variable changes according to a calculation sequence of the operation process of the trace table, generate graph information for the model through the variable tree, and store the generated graph information in the graph tree.

When data is invoked through the bytecode tracer and the invoked data is a layer provided by PyTorch, the XAI apparatus may normally perform bytecode tracing of the bytecode tracer, and when the invoked data is a layer not provided by PyTorch, the XAI apparatus may perform bytecode tracing of the bytecode tracer after performing a bytecode analysis on an unsupported code through the bytecode analyzer.

The bytecode tracer may generate a variable tree and a graph tree including slicing and operation processes when image shape is greater than or equal to a predetermined value, and may generate a variable tree and a graph tree including slicing and operation processes after transposing axes of an image through a transpose process when the image shape is smaller than the predetermined value.

The XAI apparatus may further include an algorithm decision unit configured to receive an image and an XAI algorithm as inputs and compute the generated graph to determine contribution of each gradient or image pixel to each layer through the XAI algorithm.

The XAI apparatus may further include a visualizer configured to visualize a decision-making process of the XAI algorithm for an image.

In another general aspect, there is provided a method for analyzing a model using an XAI apparatus including analyzing a computational structure of a model based on bytecode of an AI model including dynamic control flow and generating a model graph for providing visualization of decision-making process of an XAI algorithm using an analysis result.

The analyzing of the computational structure of the model may include converting a function or method of the model into bytecode and generating an operational structure table by arranging the converted bytecode.

The generating of the model graph may include analyzing the generated operational structure table and generating a graph tree using the analyzed operational structure table.

The generating of the graph tree may include storing a calculation result of an operation process in a trace table while analyzing the operational structure table, generating a variable tree by tracing a process of variable changes according to a calculation sequence of the operation process of the trace table, generating graph information for the model through the variable tree, and storing the generated graph information in the graph tree.

Other features and aspects will be apparent from the following detailed description, the drawings, and the claims.

### BRIEF DESCRIPTION OF THE DRAWINGS

FIG. 1 is a diagram illustrating the concept of an explainable artificial intelligence (XAI) according to an embodiment of the present invention.

FIG. 2 is a diagram showing a graph generated through a torch.fx module provided by the Torchvision library according to an embodiment of the present invention.

FIG. 3 is a diagram illustrating a model structure including dynamic control flow according to an embodiment of the present invention.

FIG. 4 is a diagram illustrating a Python function (a) and a converted bytecode (b) according to an embodiment of the present invention.

FIG. 5 is a diagram illustrating the configuration of an XAI apparatus according to an embodiment of the present invention.

FIG. 6 is a diagram showing a forward method (a) of a ResNet model and bytecode (b) of the forward method according to an embodiment of the present invention.

FIG. 7 is a diagram showing an operational structure table in which bytecode is arranged according to an embodiment of the present invention.

FIG. 8 is a flowchart illustrating a bytecode analysis and tracing method according to an embodiment of the present invention.

FIG. 9 is a diagram showing functional functions that correspond to OP-CODEs of the operational structure table according to an embodiment of the present invention.

FIG. 10 is a diagram showing _forward_impl function (a) and a portion (b) of the bytecode of the _forward_impl function of a model according to an embodiment of the present invention.

FIG. 11 is a diagram showing a trace table (a), a variable tree (b), and a graph tree (c) according to an embodiment of the present invention.

FIG. 12 is a diagram showing a method (a) including dynamic control flow and bytecode (b) for the dynamic control flow according to an embodiment of the present invention.

FIG. 13 is a diagram showing a variable tree 1310 and a graph tree 1320 for a model including dynamic control flow according to an embodiment of the present invention.

FIG. 14 is a diagram illustrating a variable tree 1410 and a graph tree 1420 for a model including dynamic control flow according to another embodiment of the present invention.

FIG. 15 is a diagram showing a graph tree generated for a ResNet model according to an embodiment of the present invention.

FIG. 16 is a diagram illustrating an algorithm calculation and visualization process according to an embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The advantages and features of the present invention and the manner of achieving the advantages and features will become apparent with reference to embodiments described in detail below together with the accompanying drawings. However, the present invention may be implemented in many different forms and should not be construed as being limited to the embodiments set forth herein, and the embodiments are provided such that this disclosure will be thorough and complete and will fully convey the scope of the present invention to those skilled in the art, and the present invention is defined only by the scope of the appended claims. The same reference numerals refer to the same components throughout this disclosure.

In the following description of the embodiments of the present invention, if a detailed description of related known functions or configurations is determined to unnecessarily obscure the gist of the present invention, the detailed description thereof will be omitted herein. The terms described below are defined in consideration of the functions in the embodiments of the present invention, and these terms may be varied according to the intent or custom of a user or an operator. Therefore, the definitions of the terms used herein should follow contexts disclosed herein.

Hereinafter, embodiments of the present invention will be described in detail with reference to the accompanying drawings. However, the present invention may be realized in various forms, and the scope of the present invention is not limited to such embodiments. The embodiments of the present invention are provided to aid those skilled in the art in the explanation and the understanding of the present invention.

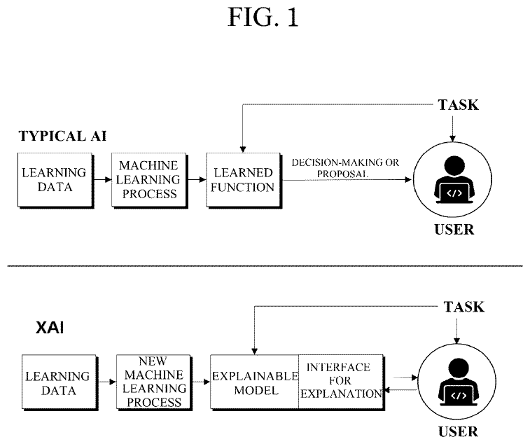

FIG. 1 is a diagram illustrating the concept of an explainable artificial intelligence (XAI, hereinafter simply referred to as “XAI”) according to an embodiment of the present invention.

Referring to FIG. 1, a layer, which is a component of an artificial intelligence (AI, referred to hereinafter as “AI”) model, is a combination of simple calculus calculations. Typically, to improve the accuracy of an AI model, various layers are connected consecutively, but this may lead to a model that is difficult to interpret in terms of the calculation process and results. Therefore, XAI has emerged to find answers to questions regarding the reliability and basis of AI model calculation results and how to improve the model.

Compared to typical AI models in machine learning (ML), XAI models provide a set of procedures and techniques that generate outputs and results that users can understand and trust, rather than requiring users to directly inspect and judge functions of learned results.

The representative features of XAI include the following:

1. Model Transparency: A feature that helps understand and explain the internal workings of an AI model.

2. Result Interpretation: A feature that aids in understanding the results generated by the model.

3. Decision-Making Process Visualization: A feature that allows the visualization of the decision-making process of the model.

4. Data Bias Detection: A feature that identifies biases present in data.

5. Reliability Provision: A feature that aids in building confidence in the predictions made by the model.

The present invention provides a model analysis method that allows the generation of a graph not only for models provided in the Torchvision library for decision-making process visualization, a representative feature of XAI, but also for various models based on PyTorch.

“Python” is a programming language commonly used in the field of research for machine learning frameworks, and “PyTorch” is being widely used as a framework. PyTorch must include a method named “forward,” where all layer structures of the model are defined. Additionally, through the “Torchvision” library, various datasets and models necessary for training, testing, and validation are provided. Representative models include models known as VGG, ResNet, and MobileNet.

There are various algorithms for visualizing the decision-making process of XAI models, such as gradient-class activation map (Grad-CAM), layer-wise relevance propagation (LRP), etc.

“Grad-CAM” refers to a technique that visualizes which region a model focuses on when making a decision. During the visualization process, a feature map may be computed for the layer selected by a user through a forward pass calculation. “Feature map” contains the features of an image created for the model to learn. After the forward pass calculation, a gradient is calculated for a specific class (result value) based on a layer specified by the user. The gradient may be calculated through backpropagation, and the calculated gradient indicates how much it contributes to the decision of the corresponding class. By multiplying the average of the gradients calculated through backpropagation to the feature map calculated through the forward pass calculation, a class activation map may be generated. The class activation map visually represents the decision-making process of the model in a way that is understandable to humans.

LRP conducts relevance propagation after the forward pass calculation. While forward pass calculation can be performed using a method provided by a machine learning framework, relevance propagation can only be calculated when the exact graph structure of the model is known. LRP activates regions with high contribution of each image pixel through a relevance propagating process and visualize them in a manner understandable to humans.

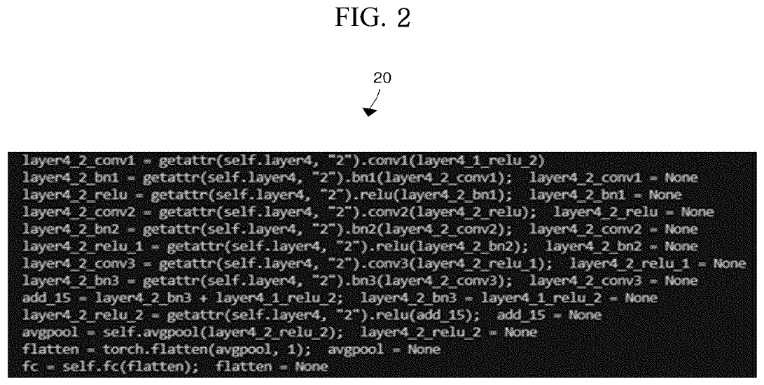

FIG. 2 is a diagram showing a graph generated through a torch.fx module provided by the Torchvision library according to an embodiment of the present invention.

Referring to FIG. 2, a graph for a model is required to obtain results from XAI algorithms, such as Grad-CAM and LRP. The graph for a model may be generated through the torch.fx module provided by the Torchvision library. The torch.fx module traces an instance of the torch.nn (neural network) module in PyTorch and creates a torch.graph. As shown in FIG. 2, the torch.graph builds the execution sequence of the operations within the module to create an objectified graph 20.

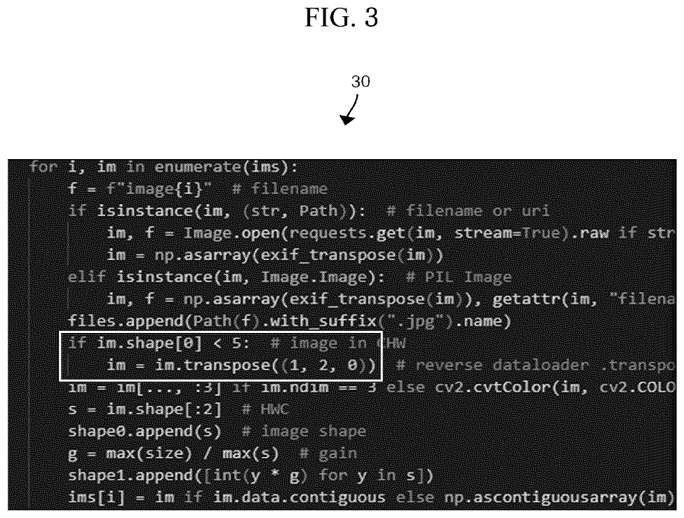

FIG. 3 is a diagram illustrating a model structure including dynamic control flow according to an embodiment of the present invention.

A model provided in the Torchvision library may be visualized for the decision-making process using a graph generated by the torch.fx module. However, as shown in FIG. 3, the torch.fx module does not support graph generation for a model 30 that includes dynamic control flow in which an output value changes depending on an input value (e.g., image shape, integer, or real number). Therefore, visualization of the decision-making process cannot be performed properly.

To address the problem of being unable to generate a graph for a model containing dynamic control flow, an XAI apparatus according to an embodiment of the present invention proposes a method to generate and trace a graph using bytecode provided in Python.

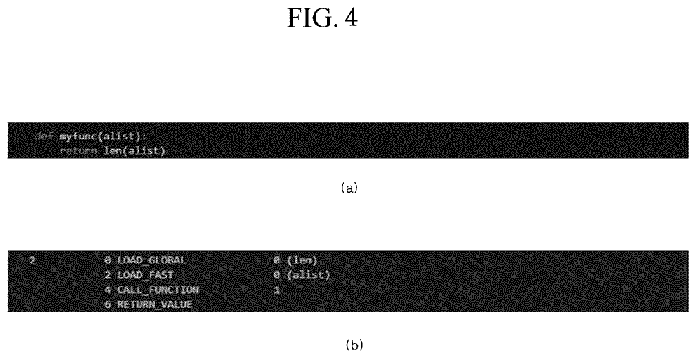

FIG. 4 is a diagram illustrating a Python function (a) and a converted bytecode (b) according to an embodiment of the present invention.

Referring to FIG. 4, the Python interpreter reads source code and converts it into bytecode, which is an intermediate form understandable by Python virtual machine (PVM). Although Python is an interpreted language, it actually compiles the source code into bytecode and interprets and executes this bytecode in the PVM. Thus, the bytecode contains information regarding all the code execution structures. FIG. 4 illustrates an example in which a Python function (a) is converted into bytecode (b).

The bytecode provides more than 100 instructions, including all flow and control structures such as variable changes, conditions, loops, function calls, etc. Thus, sufficient information is provided to analyze the execution process of the code. Since PyTorch defines the layer connection structure of the model in the forward method, analyzing the bytecode content of the forward method allows tracing of all processes of the created layer connection structure.

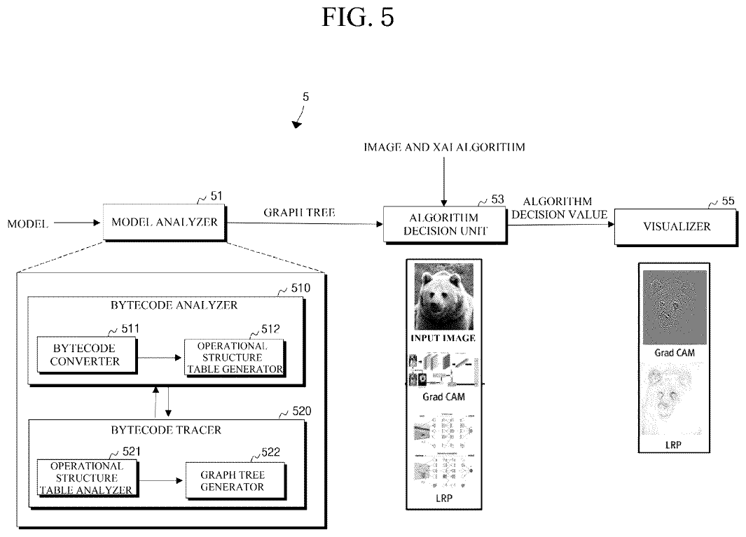

FIG. 5 is a diagram illustrating the configuration of an XAI apparatus according to an embodiment of the present invention.

Referring to FIG. 5, an XAI apparatus 5 includes a model analyzer 51, an algorithm decision unit 53, and a visualizer 55.

The XAI apparatus 5 may be implemented in the form of a computer program. The computer program may include one or more instructions, on which the methods/operations according to various embodiments of the present invention may be implemented.

The model analyzer 51 generates a graph tree by analyzing and tracing the structure of the model based on the model's bytecode. The model may be a PyTorch model.

The algorithm decision unit 53 receives an image and an XAI algorithm (such as Grad-CAM, LRP, etc.) as inputs, computes the graph tree generated through the model analyzer 51 to determine the contribution of each gradient or image pixel to each layer through the XAI algorithm.

The visualizer 55 visualizes a decision value of the XAI algorithm for the image in a way understandable to humans.

The model analyzer 51 according to an embodiment includes a bytecode analyzer 510 and a bytecode tracer 520.

The bytecode analyzer 510 analyzes the bytecode of the model's function or method to generate an operational structure table.

The bytecode analyzer 510 may include a bytecode converter 511 and an operational structure table generator 512.

The bytecode converter 511 converts a forward function or method of the model into bytecode and analyzes the converted bytecode to determine the type of operation of the function or method.

The operational structure table generator 512 arranges the bytecode to create an operational structure table (OP-CODE Table). The operational structure table generated through the operational structure table generator 512 is used as input for the bytecode tracer 520.

The bytecode tracer 520 analyzes the operational structure table received from the bytecode analyzer 510 to generate a graph tree for the model.

The bytecode tracer 520 may include an operational structure table analyzer 521 and a graph tree generator 522.

The operational structure table analyzer 521 analyzes the operational structure table.

The graph tree generator 522 utilizes the operational structure table analyzed by the operational structure table analyzer 521 to generate a graph tree for the model.

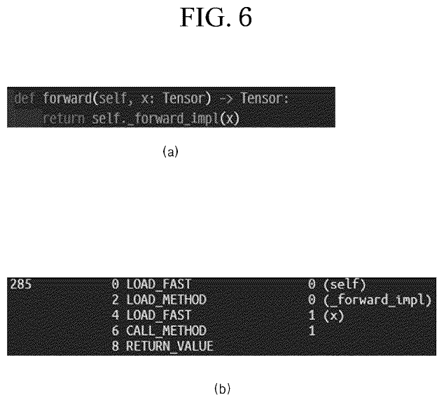

FIG. 6 is a diagram showing a forward method (a) of a ResNet model and bytecode (b) of the forward method according to an embodiment of the present invention.

Referring to FIGS. 5 and 6, the bytecode analyzer 510 analyzes bytecode of a forward method of a ResNet model shown in (a), one of the Torchvision models. The forward method shown in (a) of the ResNet model may call self.forward_impl.

FIG. 6 (b) shows bytecode for the forward method, through which the type of operation of the forward method may be determined.

In the bytecode (b), the first column represents the line number of the actual code, the second column represents the operation code (OP-CODE) of the bytecode, the third column represents the number of required arguments, and the fourth column represents the detail of an applied variable.

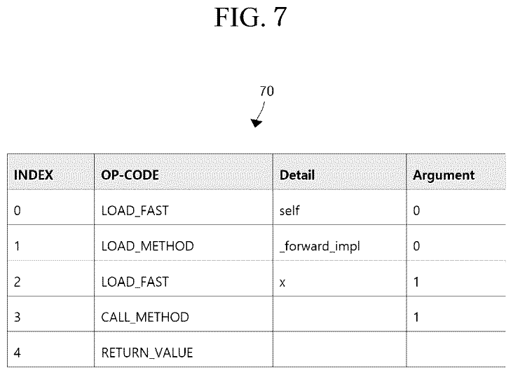

The bytecode analyzer 510 proceeds with sorting the OP-CODE, the detail of an applied variable, and the number of required arguments in the bytecode in order. The operational structure table in which the bytecode is arranged is further described with reference to FIG. 7.

FIG. 7 is a diagram showing an operational structure table in which bytecode is arranged according to an embodiment of the present invention.

Referring to FIGS. 5 to 7, the bytecode analyzer 510 arranges the bytecode to generate an operational structure table 70. For example, the bytecode analyzer 510 sorts the OP-CODE, the detail of an applied variable, and the number of required arguments in order. Once all content is sorted, the bytecode analyzer 510 transfers the sorted content to the bytecode tracer 520.

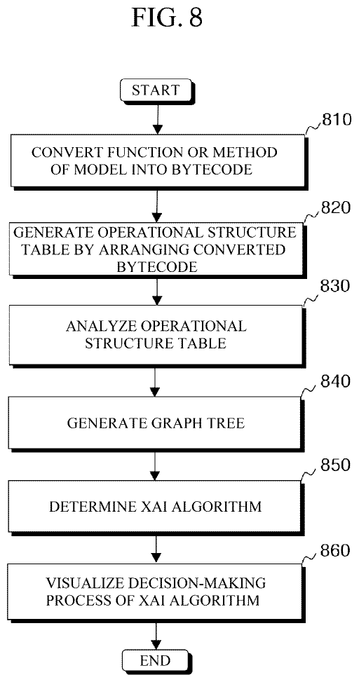

FIG. 8 is a flowchart illustrating a bytecode analysis and tracing method according to an embodiment of the present invention.

Referring to FIGS. 5 and 8, the bytecode converter 510 converts the function or method of the model into bytecode in 810.

Subsequently, the operational structure table generator 512 arranges the converted bytecode to generate the operational structure table in 820.

Next, the operational structure table analyzer 521 analyzes the operational structure table in 830.

Then, the graph tree generator 522 utilizes the analyzed operational structure table to create a trace table and a variable tree, and finally generates a graph tree in 840.

The graph tree generator 522 may generate three main data structures, the trace table, the variable tree, and the graph tree. The trace table stores the calculation results of the operation process. The variable tree stores the process of variable changes to accurately understand the actual calculation sequence of the operation process. The graph tree stores information regarding the model through the variable tree.

For dynamic control flow not supported by torch.fx, the graph tree generator 522 may properly generate the graph using the variable tree, which stores the transformation process of variables. The generated graph is used for calculations of XAI algorithms such as Grad-CAM and LRP.

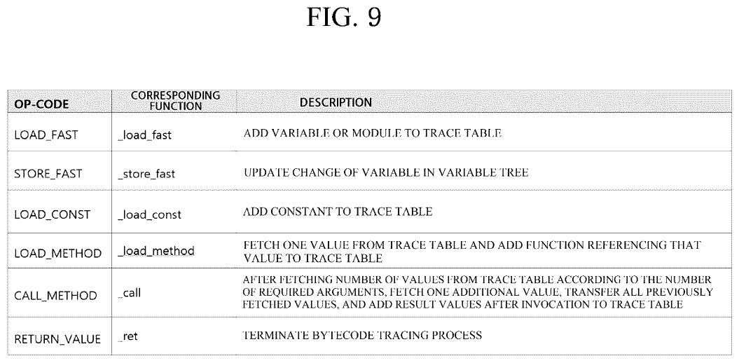

The graph tree generator 522 reads the operational structure table received from the bytecode analyzer 510 in index order and performs the corresponding function of a functional function corresponding to the OP-CODE in the operational structure table. The details of the functional function will be described below with reference to FIG. 9.

The graph tree generator 522 operates in two functions during the process of reading the operational structure table. That is, if the graph tree generator 522 is a layer provided by PyTorch from the operational structure table, the bytecode tracing of the graph tree generator 522 proceeds normally. In contrast, if the graph tree generator 522 is a layer not provided by PyTorch, after performing bytecode analysis of unsupported code through the bytecode analyzer 510, the bytecode tracing of the graph tree generator 522 proceeds.

The graph tree generator 522 generates a trace table, a variable tree, and a graph tree.

The graph tree generator 522 analyzes the operational structure table received from the bytecode analyzer in index order and generates a trace table in a stack structure while analyzing the operational structure table. The trace table stores the calculation results of the operation process.

Subsequently, the graph tree generator 522 traces the process of variable changes according to the calculation sequence of the trace table and generates a variable tree. The variable tree stores the process of variable changes to accurately understand the actual calculation sequence of the operation process.

Then, the graph tree generator 522 generates a graph tree based on the variable tree. The graph tree stores information regarding the model through the variable tree.

More specifically, the operation process of the graph tree generator 522 is as follows:

INDEX 0: Encounter an OP-CODE named LOAD_FAST and store self in the trace table.

INDEX 1: Encounter an OP-CODE named LOAD_METHOD, retrieve data (self) with the lowest depth from the trace table, and then add the _forward_impl method of the retrieved data to the trace table.

INDEX 2: Encounter an OP-CODE named LOAD_FAST and add x to the trace table.

INDEX 3: Encounter an OP-CODE named CALL_METHOD and check the number of required arguments. Here, since the number of required arguments is 1, one piece of data (x) is first fetched from the trace table. Then, the next data (self.forward_impl) is fetched and invoked from the trace table. The invoked data is divided largely into two categories: layers provided by PyTorch and layers not provided by PyTorch.

### 1) CASE 1: A Layer Provided by PyTorch

The graph tree generator 522 adds the layer to the graph tree and proceeds to the next index.

### 2) CASE 2: A Layer not Provided by PyTorch

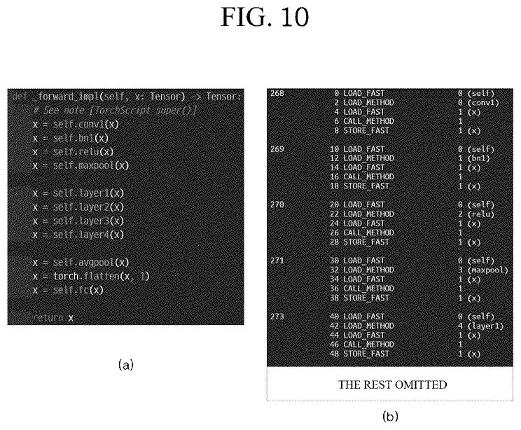

The graph tree generator 522 generates a new trace table, the bytecode analyzer 510 performs a new byte code analysis, and the bytecode tracer 520 performs a bytecode tracing process. The content of the _forward_impl function called in the new bytecode analysis process is as shown in (a) of FIG. 10, and the bytecode of the _forward_impl function is as shown in (b) of FIG. 10.

The XAI apparatus 5 conducts a new analysis and tracking process for the invoked _forward_impl function, and a returned result is added to the trace table of the invoked function before proceeding to the next INDEX.

INDEX 4: Encounter an OP-CODE named RETURN_VALUE, return the graph tree, and terminate the tracing process.

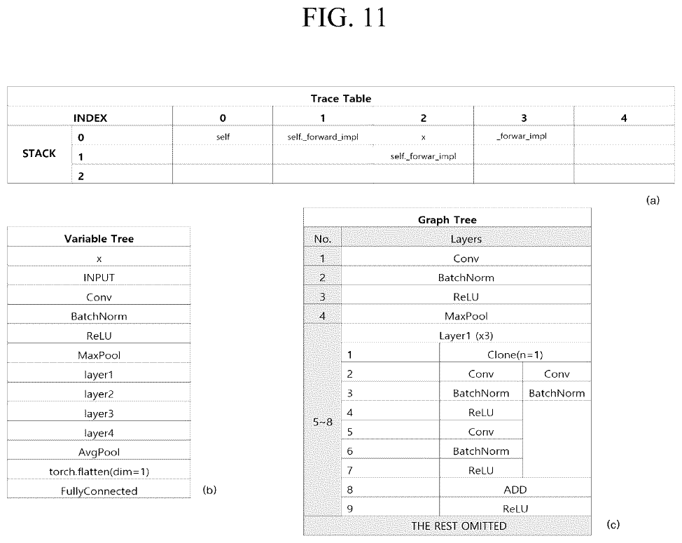

The graph tree generator 522 uses the results of analyzing the forward method into bytecode to calculate the operation process and generate a trace table ((a) in FIG. 11) containing the calculated operation process. The graph tree generator 522 then separately stores the changes in a variable for the calculated operation process in a variable tree ((b) in FIG. 11), and creates a graph tree ((c) in FIG. 11) for the model using the variable tree.

Subsequently, the XAI apparatus 5 receives the image and an XAI algorithm through the algorithm decision unit 53, and computes the generated graph to determine the contribution of each gradient or image pixel to each layer through the XAI algorithm in 850.

Then, the XAI apparatus 5 visualizes the decision-making process of the XAI algorithm for the image through the visualizer 55 in 860.

FIG. 9 is a diagram showing functional functions that correspond to OP-CODEs of the operational structure table according to an embodiment of the present invention.

FIG. 10 is a diagram showing _forward_impl function (a) and a portion (b) of the bytecode of the _forward_impl function of a model according to an embodiment of the present invention.

FIG. 11 is a diagram showing a trace table (a), a variable tree (b), and a graph tree (c) according to an embodiment of the present invention.

Referring to FIGS. 5 and 11, the graph tree generator 522 uses the results of analyzing the forward method into bytecode to calculate the operation process and generate a trace table (a) containing the calculated operation process.

Subsequently, the graph tree generator 522 generates a variable tree (b) containing the changes in a variable for the calculated operation process.

Then, the graph tree generator 522 generates a single graph tree (c) containing the changes in the variable starting from the input in the variable tree (b). In the example of the variable tree (b) shown in FIG. 11, where no changes in other variables are recorded and a single variable contains all the change process, the graph tree generator 522 may generate the graph tree c in the same manner as the variable tree (b).

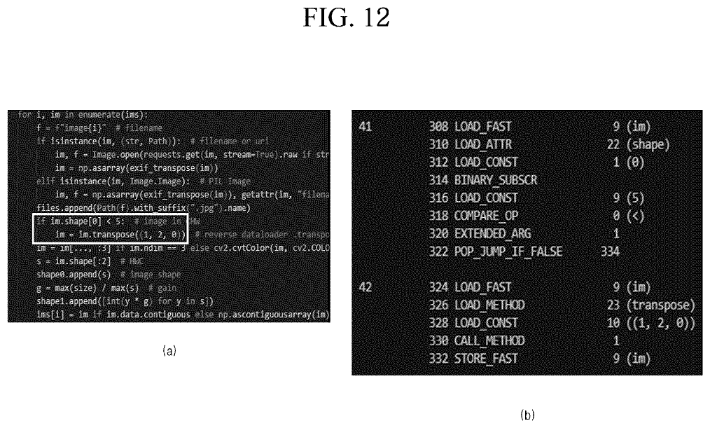

FIG. 12 is a diagram showing a method (a) including dynamic control flow and bytecode (b) for the dynamic control flow according to an embodiment of the present invention.

Referring to FIG. 12, the term “model tree including dynamic control flow” refers to the behavior of modifying an input value through a conditional or iterative structure during the forward process of the model. A model tree including such structures does not support the graph generation feature in the torch.fx module.

However, with the use of the XAI apparatus 5, it is possible to output the changes in the variable according to the input.

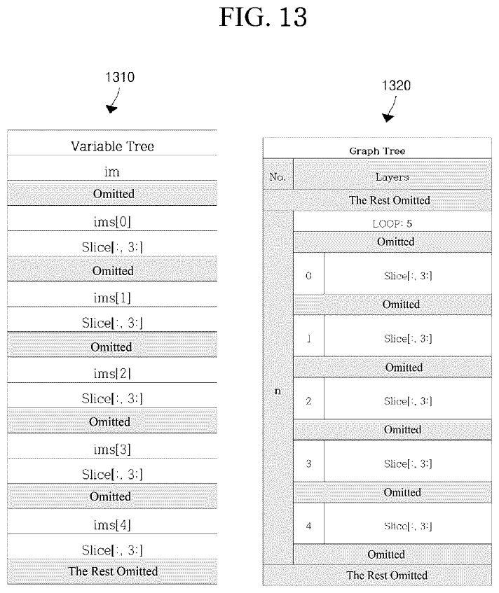

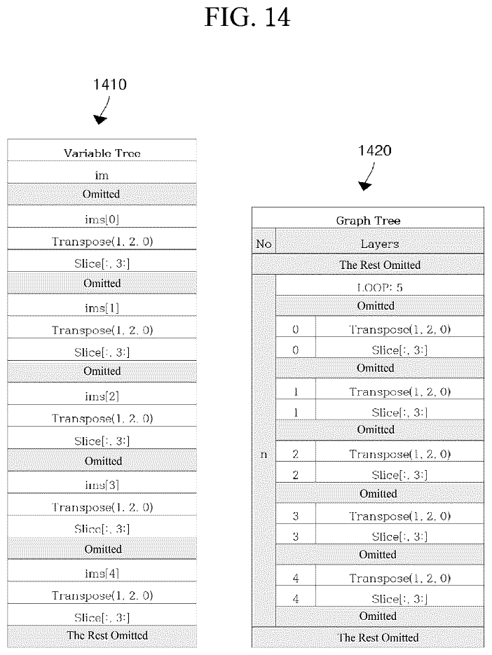

FIG. 13 is a diagram showing a variable tree 1310 and a graph tree 1320 for a model including dynamic control flow according to an embodiment of the present invention, and FIG. 14 is a diagram illustrating a variable tree 1410 and a graph tree 1420 for a model including dynamic control flow according to another embodiment of the present invention.

Referring to FIGS. 5, 13, and 14, for the model including dynamic control flow, the bytecode tracer 520 may use the operational structure table received from the bytecode analyzer 510 to generate a variable tree and a graph tree in the following two cases:

1. When an image shape is greater than or equal to a predetermined value (e.g., 5) (im.shape[0]>=5), there is no need for a transpose process for each image. Therefore, the bytecode tracer 520 generates the variable tree 1310 and the graph tree 1320 including subsequent slicing and operation processes. The image shape includes information regarding the image size (width, height).

2. When the image shape is smaller than a predetermined value (e.g., 5) (im.shape[0]<5), a transpose process for each image is included. Thus, the bytecode tracer 520 transposes the axes of the image through the transpose process and generates the variable tree 1410 and the graph tree 1420 including the subsequent slicing and operation processes.

Referring to FIGS. 5 and 14, the XAI apparatus 5 generates a variable tree for dynamic control flow to create a graph tree, and thus is capable of properly providing a graph even for the model including dynamic control flow, which is not supported by the Torch.fx module. In conclusion, the XAI apparatus 5 analyzes and traces the progress structure of PyTorch-based model to generate a graph tree.

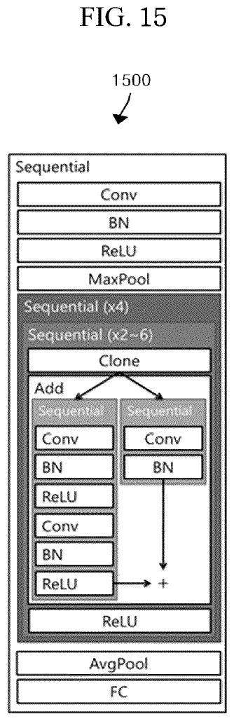

FIG. 15 is a diagram showing a graph tree generated for a ResNet model according to an embodiment of the present invention.

Referring to FIG. 15, a graph tree 1500 for a ResNet model without dynamic control flow is generated.

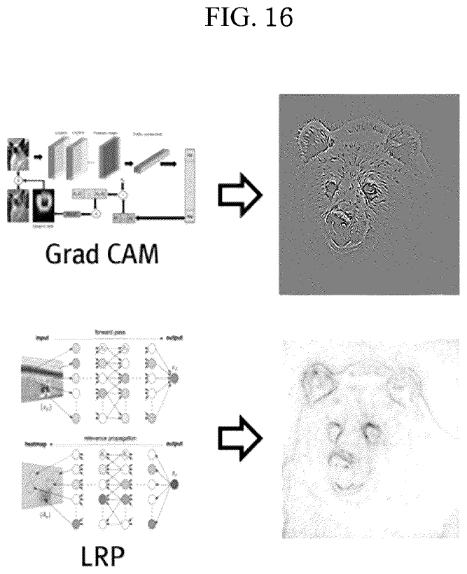

FIG. 16 is a diagram illustrating an algorithm calculation and visualization process according to an embodiment of the present invention.

Referring to FIGS. 5 and 16, the algorithm decision unit 53 computes the graph generated through the model analyzer 51 to determine the contribution of each gradient or image pixel to each layer through the XAI algorithm.

Subsequently, the visualizer 55 visualizes the decision value of the XAI algorithm. The visualizer 55 may store images visualized according to each XAI algorithm at desired locations and provide them as the results to the user.

Accordingly, the XAI apparatus 5 may visualize the decision-making process of XAI algorithms through the analysis and tracing of the model to enable the user to understand and trust it.

The present invention may use bytecode of a model to generate a graph even for models including dynamic control flow, which are otherwise unable to generate a graph, in order to provide visualization of the decision-making process of an XAI algorithm.

To calculate the decision-making process visualization function of the XAI algorithm, a graph is required. The graph represents the detailed structure of the model and is a representation that allows calculation of the XAI algorithm. While it is possible to generate a graph using the torch.fx module supported by the Torchvision library, it is not possible to generate a graph for models that include dynamic control flow, where the result value changes depending on the input value. Hence, visualization of the decision-making process cannot be provided.

The present invention can analyze all computation processes of the model based on bytecode and generate a model graph for XAI calculation based on model analysis results.

Since the present invention can obtain all instances corresponding to the graph, it ensures scalability for various PyTorch-based model analyses.

Heretofore, the present invention has been described by focusing on the exemplary embodiments. It can be understood by those skilled in the art to which the present invention pertains that the present invention can be implemented in modified forms without departing from the essential feature of the present invention. Therefore, the disclosed embodiments should be considered as illustrative rather than determinative. The scope of the present invention is defined by the appended claims rather than by the foregoing description, and all differences within the scope of equivalents thereof should be construed as being included in the present invention.

What is claimed is:

1. An explainable artificial intelligence (XAI) apparatus comprising:
a bytecode analyzer configured to analyze a computational structure of a model based on bytecode of an AI model including dynamic control flow; and
a bytecode tracer configured to generate a model graph for providing visualization of decision-making process of an XAI algorithm using an analysis result from the bytecode analyzer.

2. The XAI apparatus of claim 1, wherein the bytecode analyzer comprises a bytecode converter configured to convert a function or method of the model into bytecode and an operational structure table generator configured to generate an operational structure table (OP-CODE table) by arranging the converted bytecode.

3. The XAI apparatus of claim 2, wherein the bytecode tracer comprises an operational structure table analyzer configured to receive the operational structure table from the bytecode analyzer and analyze it and a graph tree generator configured to generate a graph tree for the model using the analyzed operational structure table.

4. The XAI apparatus of claim 3, wherein the graph tree generator is configured to store a calculation result of an operation process in the trace table while analyzing the operational structure table received from the bytecode analyzer, generate a variable tree by tracing a process of variable changes according to a calculation sequence of the operation process of the trace table, generate graph information for the model through the variable tree, and store the generated graph information in the graph tree.

5. The XAI apparatus of claim 1, wherein when data is invoked through the bytecode tracer and the invoked data is a layer provided by PyTorch, the XAI apparatus normally performs bytecode tracing of the bytecode tracer, and when the invoked data is a layer not provided by PyTorch, the XAI apparatus performs bytecode tracing of the bytecode tracer after performing a bytecode analysis on an unsupported code through the bytecode analyzer.

6. The XAI apparatus of claim 4, wherein the bytecode tracer is configured to generate a variable tree and a graph tree including slicing and operation processes when image shape is greater than or equal to a predetermined value, and may generate a variable tree and a graph tree including slicing and operation processes after transposing axes of an image through a transpose process when the image shape is smaller than the predetermined value.

7. The XAI apparatus of claim 1, further comprising an algorithm decision unit configured to receive an image and an XAI algorithm as inputs and compute the generated graph to determine contribution of each gradient or image pixel to each layer through the XAI algorithm.

8. The XAI apparatus of claim 7, further comprising a visualizer configured to visualize a decision-making process of the XAI algorithm for an image.

9. A method for analyzing a model using an explainable artificial intelligence (XAI) apparatus, the method comprising:
analyzing a computational structure of a model based on bytecode of an AI model including dynamic control flow; and
generating a model graph for providing visualization of decision-making process of an XAI algorithm using an analysis result.

10. The method of claim 9, wherein the analyzing of the computational structure of the model comprises converting a function or method of the model into bytecode and generating an operational structure table by arranging the converted bytecode.

11. The method of claim 10, wherein the generating of the model graph comprises analyzing the generated operational structure table and generating a graph tree using the analyzed operational structure table.

12. The method of claim 11, wherein the generating of the graph tree comprises
storing a calculation result of an operation process in a trace table while analyzing the operational structure table;
generating a variable tree by tracing a process of variable changes according to a calculation sequence of the operation process of the trace table;
generating graph information for the model through the variable tree; and
storing the generated graph information in the graph tree.
